(19) United States
(12) Patent Application Publication
(10) Pub. No.: US 2026/0147672 A1
(43) Pub. Date: May 28, 2026

(54) ELECTRONIC SYSTEMS, COMPUTATIONAL STORAGE SYSTEMS, HOSTS AND OPERATION METHODS

(71) Applicant: Yangtze Memory Technologies Co., Ltd., Wuhan (CN)

(72) Inventors: Tianyi Wang, Wuhan (CN); Mo Cheng, Wuhan (CN); Dongrun Qin, Wuhan (CN)

(21) Appl. No.: 19/063,003

(22) Filed: Feb. 25, 2025

(30) Foreign Application Priority Data
Nov. 25, 2024 (CN) 202411697744.3

(51) Int. Cl. G06F 11/14

(52) U.S. Cl. CPC G06F 11/1451; G06F 11/1469

(57) ABSTRACT

The application discloses an electronic system, a computational storage system, a host and operation methods, and belongs to the technical field of data storage. The electronic system comprises a computational storage system and a host, wherein the computational storage system are coupled to the host; the host is configured to transmit a command comprising indication information to the computational storage system; the computational storage system is configured to: obtain the indication information; and based on the indication information, generate snapshot information for cached data in a memory namespace and store the snapshot information in a non-volatile memory (NVM) namespace.

### CROSS-REFERENCE TO RELATED APPLICATIONS

This application claims priority to and the benefit of Chinese Patent Application 202411697744.3, filed on Nov. 25, 2024, which is hereby incorporated by reference in its entirety.

### TECHNICAL FIELD

The present disclosure relates to the technical field of data storage, in particular to electronic systems, computational storage systems, hosts and operation methods.

### BACKGROUND

With the development of storage technologies, computational storage systems exist. A computational storage system can store programs executed by the host and cached data when the host executes the programs.

The computational storage system stores cached data in memory namespaces when the host executes a program.

### BRIEF DESCRIPTION OF THE DRAWINGS

In order to more clearly describe the technical solutions in the examples of this application, the following briefly describes the accompanying drawings that need to be used in the description of the examples, and obviously, the accompanying drawings in the following description are merely some examples of this application, and for ordinary technicians in the field, other drawings can be obtained based on these drawings without exerting creative work.

FIG. 1 is a schematic diagram of an electronic system according to an example of this application;

FIG. 2 is a schematic diagram of an electronic system according to an example of this application;

FIG. 3 is a flowchart of a device's operation method according to an example of this application;

FIG. 4 is a flowchart of an operation method of a computational storage system according to an example of this application;

FIG. 5 is a schematic diagram of indication information according to an example of this application;

FIG. 6 is a schematic diagram of a memory range set according to an example of this application;

FIG. 7 is a flowchart of an operation method of a computational storage system according to an example of this application;

FIG. 8 is a schematic diagram of a management command according to an example of this application;

FIG. 9 is a flowchart of an operation method of a computational storage system according to an example of this application;

FIG. 10 is a flowchart of an operation method of a computational storage system according to an example of this application;

FIG. 11 is a flowchart of an operation method of a computational storage system according to an example of this application;

FIG. 12 is a flowchart of an operation method of a computational storage system according to an example of this application;

FIG. 13 is a schematic structural diagram of a memory card according to an example of this application;

FIG. 14 is a schematic structural diagram of a solid state drive according to an example of this application.

The accompanying drawings, which are incorporated in and constitute a part of this specification, illustrate examples consistent with the present application and together with the description serve to explain the principles of the present application.

### DETAILED DESCRIPTION

Memory namespaces are volatile, and cached data in the memory namespaces are lost in the case that a computational storage system is accidentally powered off.

To make the objectives, technical solutions, and advantages of this application clearer, the following further describes examples of this application in detail with reference to the accompanying drawings.

Examples are described in detail herein, and illustrated in the accompanying drawings. Where the following description refers to the drawings, unless otherwise indicated, like numerals in different drawings indicate the same or similar elements. The implementations described in the following examples do not represent all implementations consistent with the present application. Rather, they are merely examples of apparatuses and methods consistent with some aspects of the present application as detailed in the appended claims.

The terminology used in this application is for the purpose of describing particular examples only and is not intended to limit this application. As used in this application and the appended claims, the singular forms “a”, “the”, and “the” are also intended to include plural forms unless the context clearly indicates other meanings. It should also be understood that the term “and/or” as used herein refers to and encompasses any or all possible combinations of one or more associated listed items.

It should be noted that user information (including but not limited to user equipment information, user personal information, and the like) and data (including but not limited to data used for analysis, stored data, displayed data, and the like) involved in the present application are information and data that are authorized by the user or that are fully authorized by parties, and related laws and regulations and standards of related countries and regions need to be followed for collection, use, and processing of related data.

It should be understood that although the terms first, second, and so on may be used to describe various information in this application, these information should not be limited to these terms. These terms are only used to distinguish the same type of information from each other. For example, without departing from the scope of this application, a first parameter may also be referred to as a second parameter, and similarly, a second parameter may also be referred to as a first parameter. Depending on context, the word “if” as used herein may be interpreted as “when” or “while” or “in response to a determination.”

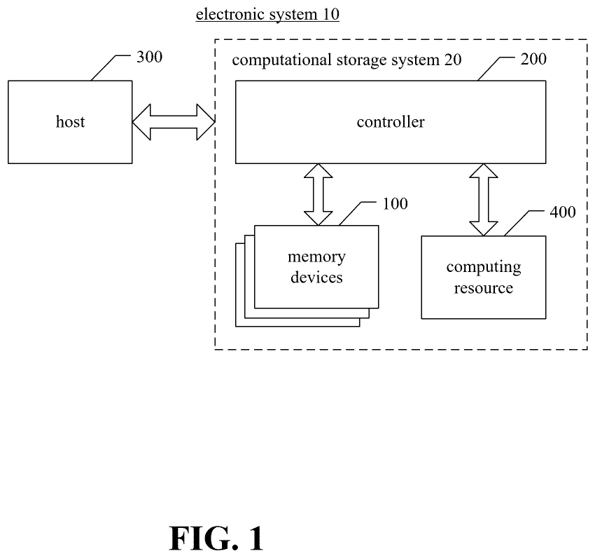

FIG. 1 is a schematic diagram of an electronic system according to an example of this application. As shown in FIG. 1, the electronic system 10 includes a host 300 and a computational storage system 20 coupled to the host 300;

The computational storage system 20 includes one or more memory devices 100, and a controller 200 coupled to and configured to control the memory devices 100.

The controller 200 may be configured to control operations performed by the memory devices 100, for example, read, erase, and program operations. The controller 200 may also be configured to manage various functions regarding data stored or to be stored in the memory devices 100, including but not limited to bad block management, garbage collection, translation of logical addresses to physical addresses, wear leveling, and the like. Optionally, the controller 200 may be further configured to process an error correcting code (ECC) on data read from or written to the memory devices 100. The controller 200 may also perform any other suitable functions, for example, formatting memory devices 100.

Controller 200 may also communicate with external devices according to a particular communication protocol. For example, the controller 200 may communicate with an external device through at least one of various interface protocols. The interface protocol may be a Universal Serial Bus (USB) protocol, a Multi-Media Card (MMC) protocol, a Peripheral Component Interconnect (PCI) protocol, a PCI-E protocol, an Advanced Technology Attachment (ATA) protocol, a Serial ATA protocol, a Parallel ATA protocol, a Small Computer System Interface (SCSI) protocol, an Enhanced Small Drive Interface (ESDI) protocol, an Integrated Development Electronics (IDE) protocol, a Firewire protocol, or the like.

In an alternative example, the controller 200, and the one or more memory devices 100 may be integrated into various types of electronic devices. The electronic device may be a mobile phone, a desktop computer, a laptop computer, a tablet computer, a vehicle computer, a game console, a printer, a positioning device, a wearable electronic device, a smart sensor, a virtual reality (VR) device, an augmented reality (AR) device, or any other suitable electronic device having storage therein. In other examples, the controller 200, and the one or more memory devices 100 may be integrated into various types of storage devices.

The memory devices 100 in the computational storage system 20 may be implemented as 3D memory devices, for example, may be 3D NAND flash.

The host 300 may be a processor (e.g., a central processing unit (CPU)) or a system on chip (SoC) (e.g., an application processor (AP)) of the electronic device. The host 300 may be configured to transmit data to the memory devices 100. Alternatively, the host 300 may be configured to receive data from the memory devices 100.

According to some implementations, the controller 200 is coupled to the host 300. The controller 200 may manage data stored in the memory devices 100 and communicate with the host 300.

The controller 200 may be configured to control operations of the memory devices 100, such as read, erase, and program operations. The controller 200 may also be configured to manage various functions regarding data stored or to be stored in the memory devices 100, including but not limited to bad block management, garbage collection, logical-to-physical address translation, wear leveling, and the like. In some implementations, the controller 200 is further configured to process error correction codes (ECCs) on data read from or written to the memory devices 100.

The controller 200 may also perform any other suitable functions, such as formatting memory devices 100. Controller 200 may communicate with external devices according to a particular communication protocol.

In some examples, the controller 200 is configured to transmit read commands to the memory devices 100.

For example, the micro control unit in the controller 200 may generate read commands, and transmit the read commands to the memory devices 100 through a memory interface in the controller 200. The memory interface may be an interface between the controller 200 and the memory devices 100.

The memory devices 100 are configured to read data stored in first memory cells in the memory devices 100 according to read commands; the first memory cells and second memory cells are located in the same memory string, and the word lines respectively coupled to the first memory cells and the second memory cells are adjacent; and the second memory cells are memory cells to which data have not been written. For example, peripheral circuit in the memory devices 100 may read data of the first memory cells in the memory cell array of the memory devices 100 according to read commands, and return the read data to the controller 200.

The controller 200 is further configured to transmit write commands to the memory devices 100.

For example, after the controller 200 receives the data returned by the memory devices 100, the micro control unit in the controller 200 may generate write commands, where the write commands may be commands for writing the data into the second memory cells. Then, the micro control unit transmits the write commands to the memory devices 100 through the memory interface in the controller 200.

The memory devices 100 are further configured to write the data read from the first memory cells into the second memory cells according to write commands. For example, the peripheral circuit in the memory devices 100 may write data into the second memory cells in the memory cell array of the memory devices 100 according to the write commands, and return a response of completion of write to the controller 200.

For example, the computational storage system 20 has a non-volatile data storage capability, for example, the memory devices 100 are provided with a non-volatile memory (NVM); for example, the computational storage system 20 is also referred to as a non-volatile memory subsystem (NVM subsystem), and has a capability of executing programs; and for example, the computational storage system 20 supports a computing program command set, and the computing program command set provides a mechanism for offloading execution of the programs from the host 300 to the NVM subsystem.

The computing program command set is an I/O command set for discovering, configuring and executing programs on a compute namespace. The data associated with programs that need to be executed are in a memory namespace or in a command data buffer of execution programs.

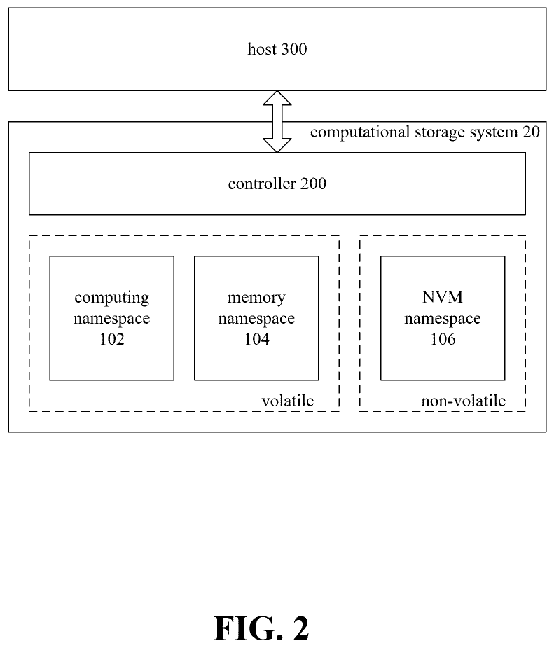

FIG. 2 is a schematic diagram of an electronic system according to an example of this application. The host 300 is coupled with a controller 200 that can manage data and/or programs stored in the computational storage system 20 and communicate with the host 300.

For example, the computational storage system 20 is provided with a computing namespace 102, a memory namespace 104, and a NVM namespace 106, where the computing namespace 102 and the memory namespace 104 are volatile, and the NVM namespace 106 is non-volatile.

The computing namespace 102 is an entity (or referred to as a hardware component) capable of executing one or more programs in a domain; it is a namespace associated with a computing program command set; for example, the controller 200 or a computing resource 400 shown in FIG. 1 is a hardware component providing the computing namespace 102. For example, the computing namespace does not have an association endurance group and a NVM set.

The memory namespace 104 is a namespace associated with a subsystem local memory command set; for example, a hardware component providing the memory namespace 104 may be at least one of a memory of a controller, a memory of a computing resource, or an independent memory. The NVM namespace 106 is a namespace associated with a NVM command set or a zoned namespace command set; for example, a hardware component providing the NVM namespace 106 may be a non-volatile memory device, and the non-volatile memory device does not lose data after being powered off.

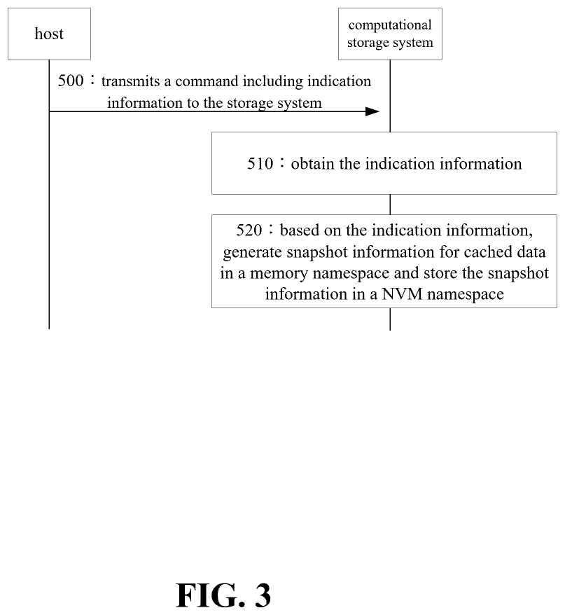

FIG. 3 is a flowchart of a device operation method according to an example of this application. The method may be performed by a computational storage system and a host. The method includes:
Operation 500: The host transmits a command including indication information to the computational storage system.

For example, operation 500 is performed by the host, the host transmits a command to the storage system, where the command carries indication information, the indication information indicating the computational storage system to generate snapshot information of a memory namespace.

For example, the command sent by the host may be a command individually constructed to indicate information, for example, an indication command or a snapshot indication command; or the indication information may also be sent by carrying the indication information in another command, for example, carrying the indication information in a management command for creating a memory range set; and this application does not limit the type and transmitting of the command.

For example, in the electronic system shown in FIG. 1, the host is configured to transmit a command including indication information to the computational storage system.
Operation 510: the computational storage system obtains indication information.

For example, the computational storage system obtains indication information included in the command, where the indication information is configured to indicating to generate the snapshot information for the memory namespace. For example, as described above, the indication information may be all or part of information in the command sent by the host, where the command sent by the host may be a command individually constructed for communicating information or a known command that further includes other information.

In an implementation, a controller in the computational storage system obtains the indication information of the memory namespace; for example, in the electronic system shown in FIG. 1, the controller is configured to obtain the indication information; or the computational storage system is configured to obtain the indication information.
Operation 520: based on the indication information, the computational storage system generates the snapshot information for cached data in the memory namespace and stores the snapshot information in the NVM namespace.

For example, the snapshot information is backup information for the cached data, which is a disaster recovery backup of the cached data in the memory namespace in the NVM namespace, and the security of the cached data in the memory namespace is improved by storing the snapshot information; for example, the snapshot information may be configured to restore the cached data when the cached data are lost, so as to improve the security of the cached data and avoid accidental loss of the cached data. In an example, the snapshot information is generated for part of information in the memory namespace, the cached data being part of information that needs to be backed up in the memory namespace. Further, the command in which the indication information is located indicates identity information of the cached data, for example, the command in which the indication information is located indicates a storage path of the cached data, to indicate which information in the memory namespace is data that needs to be backed up to generate the snapshot information, which will be described below in a form of an individual example. In this application, a case in which the snapshot information is generated for all information in the memory namespace is not excluded.

For example, the snapshot information may be a duplicate copy of the cached data, or may be obtained after compression is performed on the cached data. In some examples, the snapshot information carries time information, the time information being configured to indicate a moment of generating the snapshot information.

For example, the snapshot information is configured to restore cached data in the memory namespace in the case of missing information in the memory namespace. The restored cached data is the same as the cached data in the memory namespace at the moment of generating the snapshot information.

For example, the storage location of the snapshot information in the NVM namespace may be determined based on the indication information, or the snapshot information may be stored at a sequential location in the NVM namespace. This application does not limit the storage location of the snapshot information. In some examples, the controller in the computational storage system writes the snapshot information in the NVM namespace, for example, the controller obtains cached data in the memory namespace, and stores the snapshot information generated based on the cached data in the NVM namespace.

In an implementation, based on the indication information the controller in the computational storage system generates snapshot information for the cached data in the memory namespace and stores the snapshot information in the NVM namespace; for example, in the electronic system shown in FIG. 1, the controller is configured to: based on the indication information, generate the snapshot information for the cached data in the memory namespace and store the snapshot information in the NVM namespace; or the computational storage system is configured to generate the snapshot information for the cached data in the memory namespace and store the snapshot information in the NVM namespace.

Further, the controller is further configured to: based on the indication information, generate the snapshot information for the cached data and store the snapshot information in a memory device; and the cached data are stored in a memory. For example, the memory device is a hardware component that provides a NVM namespace; the memory is a hardware component that provides a memory namespace; and for example, the memory may be at least one of a memory of a controller, a memory of a computing resource, or an independent memory.

The controller stores the snapshot information in the memory device, the snapshot information being constructed based on the cached data, the cached data being stored in the memory of the controller or in computing resources of the computational storage system.

In conclusion, according to the method provided in this example, by generating the snapshot information in the NVM namespace, the cached data in the memory namespace is backed up in a non-volatile manner; the snapshot information is stored in the NVM namespace, so that the snapshot information will not be lost even if the computational storage system is accidentally powered off; a foundation is laid for restoring the cached data in the case of missing information in the memory namespace; and a problem that the cached data is lost and cannot be restored in the related art is avoided.

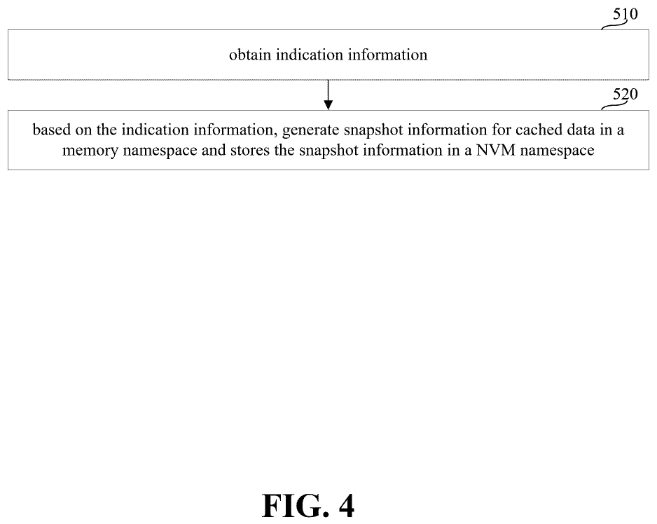

In an optional implementation of this application, operation 510 and operation 520 in the device operation method described in FIG. 3 can be combined into a new example for independent implementation; FIG. 4 is a flowchart of an operation method of a computational storage system according to an example of this application. The method may be performed by a computational storage system. Optionally, the method may be performed by a controller in a computational storage system. For descriptions of operation 510 and operation 520 in FIG. 4, refer to FIG. 3, and details are not described here again.

Next, the indication information is further described as follows.

In an optional design of this application, the indication information includes a first field, the first field being one or more bytes in the indication information. It can be understood that the first field is all or part of the indication information.

For example, the first field is configured to indicate to generate the snapshot information for the cached data in the memory namespace. The host indicates to the computational storage system to generate the snapshot information by using the first field having one or more bytes. For example, the first field indicating to generate the snapshot information may be determined through pre-negotiation between the host and the computational storage system, or may be indicated by the host to the computational storage system, or may be indicated by the computational storage system to the host, or may be supported in a data transmission specification between the host and the computational storage system. The way of the first field indicating to generate the snapshot information is not limited in this application.

For example, one or more bytes in the first field may have different values. Further, when the first field has a first value, the first field is configured to indicate to generate the snapshot information of the memory namespace. For example, a quantity of bytes of the first field is 2, and the first value is 01. It may be understood that the first value being 01 is merely an example of description, and another quantity of bytes may alternatively be implemented in different implementations.

In another example, when the first field has the second value, the first field is configured to indicate not to generate the snapshot information of the memory namespace. For example, the quantity of bytes of the first field is 2, and the second value is 00; when the first field has the second value, the first field is configured to indicate not to generate the snapshot information of the memory namespace. It may be understood that the second value being 00 is merely an example of description, and another quantity of bytes may alternatively be implemented in different implementations.

In an optional implementation of this application, not only the first field, the indication information further includes at least one of a second field, a third field, and a fourth field.

Regarding the second field:
The second field is configured to indicate a frequency for generating the snapshot information, the frequency of the snapshot information indicating a number of times of generating the snapshot information in unit time, where the unit time may be any one of second, millisecond, minute, hour, day, and the like.

Further, operation 520 described above may be implemented as follows:
based on the indication information, at a first frequency indicated by the second field, the snapshot information for the cached data in the memory namespace is generated and the snapshot information is stored in the NVM namespace.

For example, the first frequency is obtained by the controller from the indication information, and the computational storage system generates the snapshot information in response to the first field in the indication information when generating the snapshot information of the cached data; and under a constraint of the second field in a process of generating the snapshot information, the snapshot information is generated at the first frequency, where the first frequency is a number of times that the snapshot information is generated per unit time and that is indicated by the second field.

In an implementation, based on the indication information, at the first frequency indicated by the second field, the controller in the computational storage system generates the snapshot information for the cached data in the memory namespace and stores the snapshot information in the NVM namespace; for example, in the electronic system shown in FIG. 1, the controller is configured to: based on the indication information, at the first frequency indicated by the second field, generate the snapshot information for the cached data in the memory namespace and store the snapshot information in the NVM namespace; or the computational storage system is configured to: based on the indication information, at the first frequency indicated by the second field, generate the snapshot information for the cached data in the memory namespace and store the snapshot information in the NVM namespace.

Regarding the third field:
The third field is configured to indicate an identity of the NVM namespace; one or more NVM namespaces may be provided in the computational storage system; for example, a hardware component corresponding to the NVM namespace is a memory device in the computational storage system. For example, the identity of the NVM namespace carried in the third field indicates, by using the identity, the NVM namespace in the computational storage system in which the snapshot information needs to be stored.

Further, operation 520 described above may be implemented as follows:
based on the indication information, the snapshot information for the cached data in the memory namespace is generated, and is stored in the NVM namespace with the identity indicated by the third field being a first identity.

For example, the first identity is obtained by the controller from the indication information, and when generating the snapshot information of the cached data, the computational storage system generates the snapshot information in response to the first field in the indication information; and under a constraint of the third field in a process of generating the snapshot information, the snapshot information is stored in the NVM namespace with the identity indicated by the third field being the first identity. In an example, the identity of the NVM namespace storing the snapshot information is the same as the identity indicated by the third field.

In an implementation, based on the indication information, the controller in the computational storage system generates the snapshot information for the cached data in the memory namespace and stores the snapshot information in the NVM namespace with the identity indicated by the third field being the first identity; for example, in the electronic system shown in FIG. 1, the controller is configured to: based on the indication information, generate the snapshot information for the cached data in the memory namespace and store the snapshot information in the NVM namespace with the identity indicated by the third field being the first identity; or the computational storage system is configured to: based on the indication information, generate the snapshot information for the cached data in the memory namespace and store the snapshot information in the NVM namespace with the identity indicated by the third field being the first identity.

Regarding the fourth field:
The fourth field is configured to indicate a start storage location of the snapshot information in the NVM namespace; the NVM namespace is provided with a data storage space, the fourth field carries a storage location, and the storage location is a start location for storing the snapshot information in the NVM namespace.

Further, operation 520 described above may be implemented as follows:
based on the indication information, the snapshot information for the cached data in the memory namespace is generated and the snapshot information is stored in the NVM namespace with a first logical location indicated by the fourth field as a start location.

For example, the first logical location is obtained by the controller from the indication information, and when generating the snapshot information of the cached data, the computational storage system generates the snapshot information in response to the first field in the indication information; and under a constraint of the fourth field in a process of generating the snapshot information, the snapshot information is stored with the first logical location indicated by the fourth field as the start location.

In an implementation, based on the indication information, the controller in the computational storage system generates the snapshot information for the cached data in the memory namespace and stores the snapshot information in the NVM namespace with the first logical location indicated by the fourth field as the start location; for example, in the electronic system shown in FIG. 1, the controller is configured to: based on the indication information, generate the snapshot information for the cached data in the memory namespace and store the snapshot information in the NVM namespace with the first logical location indicated by the fourth field as the start location; or the computational storage system is configured to: based on the indication information, generate the snapshot information for the cached data in the memory namespace and store the snapshot information in the NVM namespace with the first logical location indicated by the fourth field as the start location.

It should be noted that, as described above, on the basis of including the first field, the indication information further includes at least one of the second field, the third field, and the fourth field. In an example, the indication information includes the first field to the fourth field described above. Correspondingly, operation 520 described above may be implemented as: based on the indication information, at the first frequency indicated by the second field, generating the snapshot information for the cached data in the memory namespace, and in the NVM namespace with the identity indicated by the third field being the first identity, storing the snapshot information with the first logical location indicated by the fourth field as the start location.

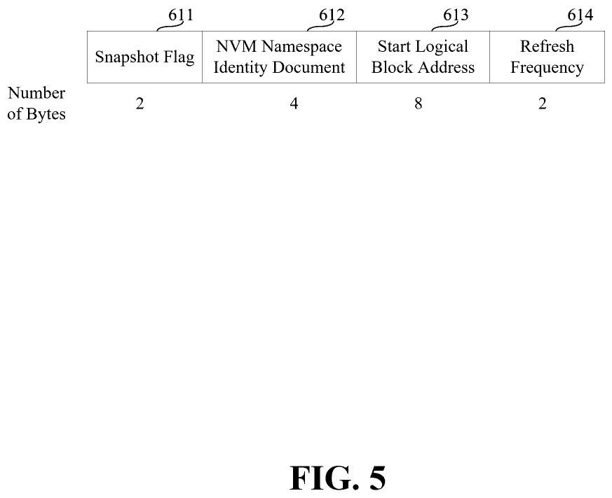

FIG. 5 provides a schematic diagram of the indication information according to an example of this application, the indication information including the following fields: a Snapshot Flag 611, a NVM Namespace Identity Document 612, a Start Logical Block Addressing (Start LBA) 613, and a Refresh Frequency 614.

In an optional implementation, FIG. 5 further shows a quantity of bytes (Octets) of a field included in the indication information, for example, a quantity of bytes of the Snapshot Flag 611 is 2, a quantity of bytes of the NVM Namespace Identity Document 612 is 4, a quantity of bytes of the Start Logical Block Addressing 613 is 8, and a quantity of bytes of the Refresh Frequency 614 is 2. It may be understood that a quantity of bytes in each filed in FIG. 5 and a sequence of bytes in FIG. 5 are merely an example for description, and another quantity of bytes may alternatively be implemented in different implementations. For example, to be concise, refer to the first field as described above for an introduction of the Snapshot Flag 611 in FIG. 5, refer to the third field as described above for an introduction of the NVM Namespace Identity Document 612, refer to the fourth field as described above for an introduction of the Start Logical Block Addressing 613, and refer to the second field as described above for an introduction of the Refresh Frequency 614, and details are not described herein again.

Next, a command including the indication information is further introduced.

In an optional design of this application, the command including the indication information is implemented as a management command, the management command comprising the indication information. For example, the management command is configured to create a memory range set, and the management command is also referred to as a memory range set management command.

The memory range set is a set of at least one memory range in a memory namespace; for example, the memory range is configured to indicate a segment of memory in a subsystem local memory (SLM) provided by the computational storage system. For example, the memory range is specified by a memory namespace ID (MNSID), an offset, and a length. The memory range set is configured to indicate at least one memory range in which the computational storage system provides a cache for a program during execution of the program.

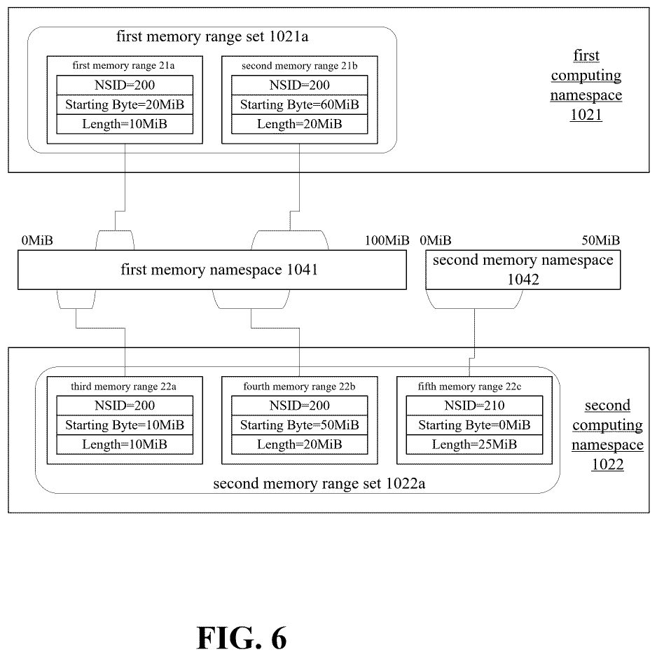

FIG. 6 is a schematic diagram of a memory range set according to an example of this application.

The memory range set is created in the computing namespace, the memory range set being configured to limit access of a program executed in the computational storage system to a subset of the subsystem local memory ; and an example in which a first memory range set 1021a is created in a first computing namespace 1021 and a second memory range set 1022a is created in a second computing namespace 1022 is used for description.

For the first memory range set 1021a, the first memory range set 1021a is a set of a first memory range 21a and a second memory range 21b; and the memory range is configured to indicate a segment of memory in a subsystem local memory namespace.

Specifically, a namespace identity (NSID) recorded in the first memory range 21a=200, a Starting Byte=20 MiB, and a Length=10 MiB; and the first memory range 21a indicates a segment of memory with a length of 10 MiB with a start position of 20 MiB and an end position of 30 MiB in the first memory namespace 1041 with a namespace identity of 200.

NSID=200, Starting Byte=60 MiB, Length=20 MiB are recorded in the second memory range 21b; the second memory range 21b indicates a segment of memory with a length of 20 MiB with a start position of 60 MiB and an end position of 80 MiB in the first memory namespace 1041 with a namespace identity of 200.

For the second memory range set 1022a, the second memory range set 1022a is a set of a third memory range 22a, a fourth memory range 22b, and a fifth memory range 22c.

Specifically, NSID=200, Starting Byte=10 MiB, and Length=10 MiB are recorded in the third memory range 22a; and the third memory range 22a indicates a segment of memory with a length of 10 MiB with a start position of 10 MiB and an end position of 20 MiB in the first memory namespace 1041 with a namespace identity of 200.

NSID=200, Starting Byte=50 MiB, Length=20 MiB are recorded in the fourth memory range 22b; the fourth memory range 22b indicates a segment of memory with a length of 20 MiB with a start position of 50 MiB and an end position of 70 MiB in the first memory namespace 1041 with a namespace identity of 200.

NSID=210, Starting Byte=0 MiB, Length=25 MiB are recorded in the fifth memory range 22c; the fifth memory range 22c is configured to indicate a segment of memory with a length of 25 MiB with a start position of 0 MiB and an end position of 25 MiB in the second memory namespace 1042 with a namespace identity of 210.

Further, the computational storage system creates, based on a management command, a memory range set including at least one memory address in a memory namespace, cached data being stored on the memory address; and the memory range set includes a memory address of the cached data in the memory namespace.

For example, the cached data is configured to store at least one of an input cache, an output cache, and a temporary data cache during execution of programs in the computational storage system. For example, the computational storage system has a capability of executing a program, and the memory range set is configured to indicate at least one memory range in which the computational storage system provides a cache for the program during execution of the program. For example, the input cache is a cache constructed for input data of a program in a memory namespace; the output cache is a cache constructed for output data of a program in the memory namespace; and the temporary data cache is a cache constructed for an intermediate calculation result generated during execution of the program in the memory namespace. At least one of the input cache, the output cache, and the temporary data cache is stored in the memory namespace. When the data are used during the execution of the program again, the data can be quickly obtained from the memory namespace, recalculation of the data is avoided, and efficiency of execution of the program is improved.

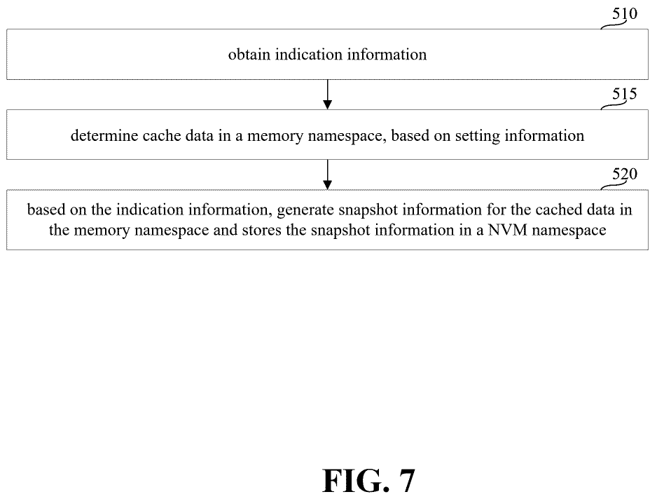

FIG. 7 is a flowchart of an operation method of a computational storage system according to an example of this application. The method may be performed by a computational storage system. Optionally, the method may be performed by a controller in the computational storage system. That is, based on the example shown in FIG. 4, operation 515 is further included.
Operation 515: determining cached data in the memory namespace based on setting information.

For example, the setting information is configured to indicate a location of at least one memory range of the memory range set in the memory namespace. The setting information indicates a memory address of the cached data in the memory namespace included in the memory range set.

For example, the at least one memory range indicated by the setting information includes the memory address of the cached data in the memory namespace, and the cached data is determined based on the setting information. For example, the indication information included in the management command is configured to indicate to generate the snapshot information for the created memory range set.

In an implementation, the controller in the computational storage system determines the cached data in the memory namespace based on the setting information; for example, in the electronic system shown in FIG. 1, the controller is configured to determine the cached data in the memory namespace based on the setting information; or the computational storage system is configured to determine the cached data in the memory namespace based on the setting information.

In an optional implementation, the setting information is configured to indicate at least one of the following:
A length of the memory range is a length of the memory range that needs to be created and that is described in units of bytes. A Memory Namespace ID (MNSID) corresponding to the memory range is an identity of the memory namespace to which a segment of memory indicated by the memory range set belongs; for example, the MNSID is an identity of the memory namespace that stores cached data for which snapshot information needs to be constructed; and similar to a NVM namespace, one or more memory namespaces may be provided in the computational storage system. The start location is the start storage location for the created memory range in the memory namespaces.

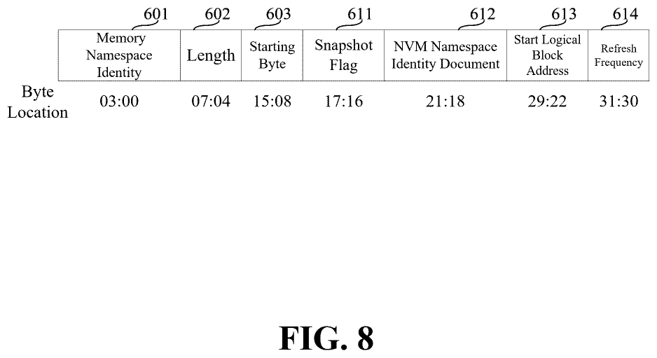

FIG. 8 provides a schematic diagram of the management command according to an example of this application, the management command including the setting information and the indication information; the setting information includes the following fields: a Memory Namespace Identity 601 (also referred to as a namespace identity NSID), a length 602, and a starting byte 603; a byte location of the memory namespace identity 601 is from byte 00 to byte 03, and a quantity of bytes is 4; a byte location of the length 602 is from byte 04 to byte 07, and a quantity of bytes is 4; and a byte location of the starting byte 603 is from byte 08 to byte 15, and a quantity of bytes is 8. For example, in FIG. 5, the starting location of the memory range is indicated in unit of bytes.

The indication information includes the following fields: a snapshot flag 611, NVM namespace identity document 612, a start logical block addressing 613, and a refresh frequency 614. A byte location of the snapshot flag 611 is from byte 16 to byte 17, and a quantity of bytes is 2; a byte location of the NVM namespace identity document 612 is from byte 18 to byte 21, and a quantity of bytes is 4; a byte location of the start logical block addressing 613 is from byte 22 to byte 29, and a quantity of bytes is 8; and a byte location of the refresh frequency 614 is byte 30 to byte 31, and a quantity of bytes is 2.

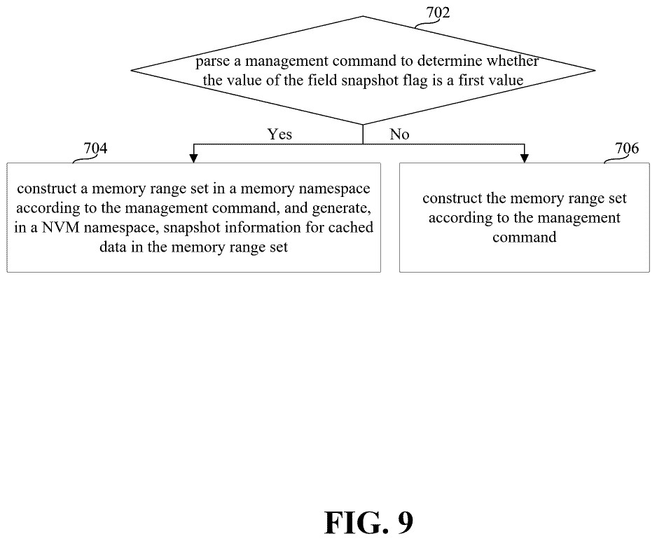

FIG. 9 is a flowchart of an operation method of a computational storage system according to an example of this application. The method may be performed by a computational storage system. Optionally, the method may be performed by a controller in a computational storage system. The method includes:
Operation 702: parsing a management command to determine whether the value of the field snapshot flag is a first value.

For example, the field snapshot flag in the management command is also referred to as a first field, and when the field snapshot flag is the first value, the field snapshot flag indicates to generate snapshot information of a memory namespace, and operation 704 is performed. When the value of the field snapshot flag is not the first value (for example, is a second value), it indicates not to generate the snapshot information of the memory namespace, and operation 706 is performed. For incomplete descriptions of the first field, the first value, and the second value, refer to the foregoing descriptions of the indication information and descriptions in FIG. 5, and details are not described herein again.
Operation 704: constructing a memory range set in the memory namespace according to the management command, and generating, in a NVM namespace, the snapshot information for cached data in the memory range set.

For example, this operation is performed when the field snapshot flag is the first value; and the management command is configured to construct the memory range set, and in response to an indication of the field snapshot flag in the management command, the snapshot information is generated for the cached data in the memory range set in the NVM namespace.
Operation 706: constructing the memory range set according to the management command.

For example, this operation is performed when the value of the field snapshot flag is different from the first value; the management command is configured to construct the memory range set; and when the value of the field snapshot flag in the management command is different from the first value, it indicates not to generate the snapshot information of the memory namespace, and only to construct the memory range set. The memory range set is a set of at least one memory range in the memory namespace; for example, the memory range is configured to indicate a segment of memory in the memory namespace.

In conclusion, according to the method provided in this example, by carrying the indication information in the management command, the snapshot information is generated in the NVM namespace, and the cached data in the memory namespace is backed up in a non-volatile manner; the management command includes the setting information and the indication information, and on the basis of being compatible with each field of the setting information in the related art, at the same time, the management command indicates the computational storage system to generate the snapshot information; a foundation is laid for restoring the cached data in the case of missing information in the memory namespace; and the problem that the cached data is lost and cannot be restored in the related art is avoided.

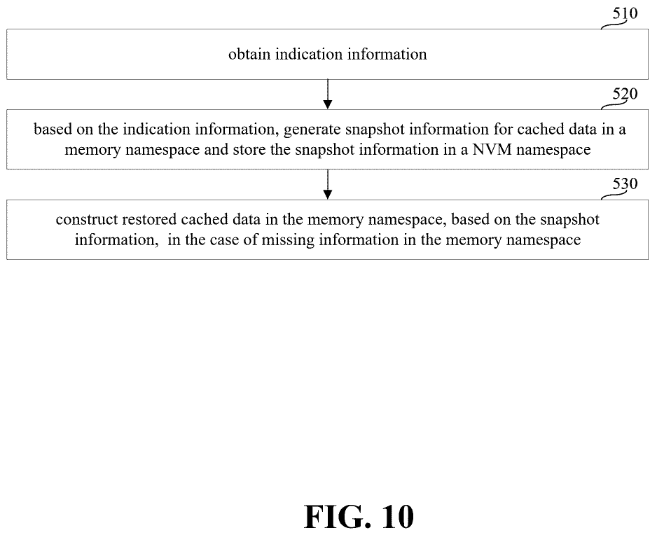

FIG. 10 is a flowchart of an operation method of a computational storage system according to an example of this application. The method may be performed by a computational storage system. Optionally, the method may be performed by a controller in a computational storage system. That is, based on the example shown in FIG. 4, operation 530 is further included.
Operation 530: constructing restored cached data in the memory namespace, based on the snapshot information, in the case of missing information in the memory namespace.

For example, the reason for missing information in the memory namespace may be that a hardware component providing the memory namespace is damaged, or may be that data in the memory namespace is volatile, and data stored in the memory namespace is lost after the computational storage system is powered off; this example does not limit the reason for missing information in the memory namespace.

As described above, the snapshot information may be a duplicate copy of the cached data, or may be obtained by compressing the cached data; correspondingly, based on the snapshot information, the way of constructing and restoring the cached data in the memory namespace may be directly copying the duplicate copy of the cached data, or may be obtained by decompressing the snapshot information.

In an implementation, the controller in the computational storage system constructs the restored cached data in the memory namespace, based on the snapshot information, in the case of missing information in the memory namespace; for example, in the electronic system shown in FIG. 1, the controller is configured to construct the restored cached data in the memory namespace, based on the snapshot information, in the case of missing information in the memory namespace; or the computational storage system is configured to construct the restored cached data in the memory namespace, based on the snapshot information, in the case of missing information in the memory namespace.

In an optional implementation, this operation may be implemented as follows.

In a case that the computational storage system is powered on again after being powered off, constructing the restored cached data in the memory namespace, based on the snapshot information;

For example, data stored in the memory namespace is volatile, and when the computational storage system is powered on again after being powered off, cached data stored before being powered off is lost, and a requirement for restoring the cached data exists. For example, the reason for powering off the computational storage system may be that the computational storage system is disconnected from the host, or may be that power supply of the computational storage system is accidentally interrupted or manually turned off by a user. The reason for the powering off is not limited in this application.

In an implementation, when the controller in the computational storage system is powered on again after the computational storage system is powered off, the controller constructs the restored cached data in the memory namespace, based on the snapshot information; for example, in the electronic system shown in FIG. 1, the controller is further configured to: construct the restored cached data in the memory namespace, based on the snapshot information, when the computational storage system is powered on again after the computational storage system is powered off; or the computational storage system is further configured to: construct the restored cached data in the memory namespace, based on the snapshot information, when the computational storage system is powered on again after the computational storage system is powered off.

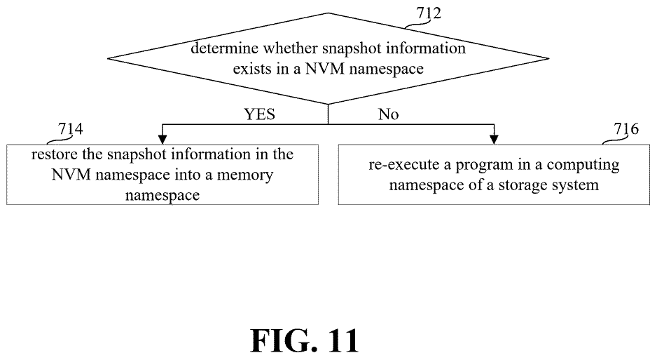

FIG. 11 is a flowchart of an operation method of a computational storage system according to an example of this application. The method may be performed by a computational storage system. Optionally, the method may be performed by a controller in a computational storage system. The method includes:
Operation 712: determining whether snapshot information exists in a NVM namespace.

For example, whether the snapshot information exists in the NVM namespace is determined according to at least one of a storage location, a format, and an information name of the snapshot information; and for example, the foregoing information may be recorded when the snapshot information is constructed. Alternatively, when a first field is a first value, it may indicate that the snapshot information exists in the NVM namespace.

For example, when the snapshot information exists in the NVM namespace and backup information is constructed before the cached data is lost, operation 714 is performed; or when snapshot information does not exist in the NVM namespace and backup information is not constructed before the cached data is lost, operation 716 is performed.
Operation 714: restoring the snapshot information in the NVM namespace into the memory namespace.

For example, this operation is performed when the snapshot information exists in the NVM namespace; and the snapshot information is directly copied to the memory namespace to construct the restored cached data, where the restored cached data is the same as cached data in the memory namespace at the moment of generating the snapshot information.
Operation 716: re-executing a program in a computing namespace of the storage system.

For example, this operation is performed when no snapshot information exists in the NVM namespace; because no snapshot information exists in the NVM namespace, cached data in the memory namespace cannot be restored, and by re-executing the program in the computing namespace of the storage system, cached data of the program is stored in the memory namespace during an execution process of the program.

In conclusion, according to the method provided in this example, by generating the snapshot information in the NVM namespace, the cached data in the memory namespace is backed up in a non-volatile manner; the snapshot information is stored in the NVM namespace, and the snapshot information will not be lost even if the computational storage system is accidentally powered off; in the case of missing information in the memory namespace, restored cached data is obtained based on the snapshot information, so that the cached data at the moment of generating the snapshot information is restored; and the problem that the cached data is lost and cannot be restored in the related art is avoided.

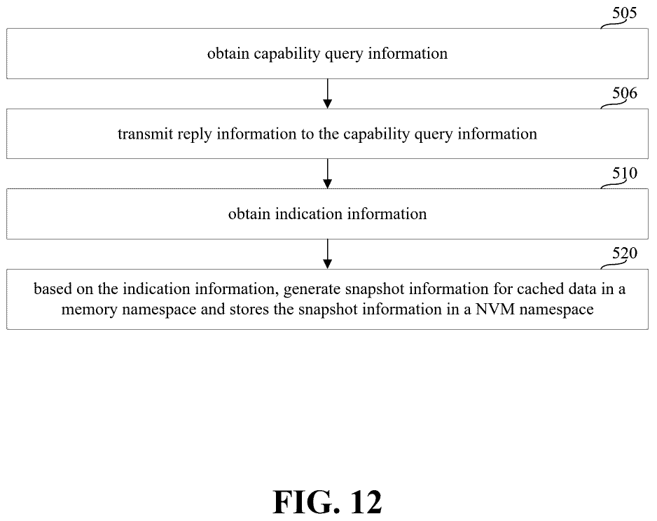

FIG. 12 is a flowchart of an operation method of a computational storage system according to an example of this application. The method may be performed by a computational storage system. Optionally, the method may be performed by a controller in a computational storage system. That is, based on the example shown in FIG. 4, operations 505 and 506 are further included.
Operation 505: obtaining capability query information.

For example, the capability query information is sent by the host to the computational storage system; and for example, the host transmits a command including the capability query information to the computational storage system. For example, the command in this operation and the command described in operation 500 in FIG. 3 are usually different commands, but the case of being the same command is not excluded. For example, the command including the capability query information is an identify command.

In an implementation, the controller in the computational storage system obtains the capability query information; for example, in the electronic system shown in FIG. 1, the controller is configured to obtain the capability query information; or the computational storage system is configured to obtain the capability query information.

For example, the capability query information is sent by the host to the computational storage system, and the operation 500 in FIG. 3 and the host transmitting the capability query information to the computational storage system may be combined into a new example to be implemented independently; in the electronic system shown in FIG. 1, the host is further configured to transmit the capability query information to the computational storage system.
Operation 506: transmitting reply information to the capability query information.

For example, the reply information is feedback information for the capability query information, and a Memory Range Snapshot Supported of one byte indicates whether the computational storage system has a capability of generating snapshot information in the NVM namespace; and further, when the value of the field Memory Range Snapshot Supported is a first value (for example, 1), the reply information is configured to indicate that the computational storage system has the capability of generating snapshot information in the NVM namespace.

For example, when the host transmits the capability query information to the computational storage system by using the identify command, the data structure of the reply information is a data structure of Identify I/O Command Set that is provided by the controller. The field snapshot supported is a byte in a Reserved field in the data structure. For example, in a data structure of an Identify I/O command set that is provided by the controller, a Version (VER) field is from byte location of byte 00 to byte location of byte 03, the version (VER) field including a specification version descriptor which indicate a specification version supported by the controller. Byte locations from byte 04 to byte 4095 are reserved fields.

In an implementation, the controller in the computational storage system transmits reply information to the capability query information; for example, in the electronic system shown in FIG. 1, the controller is configured to transmit the reply information to the capability query information; or the computational storage system is configured to transmit the reply information to the capability query information.

In conclusion, according to the method provided in this example, whether the computational storage system has the capability of generating the snapshot information in the NVM namespace is queried by the host by using the capability query information; by generating the snapshot information in the NVM namespace, cached data in the memory namespace is backed up in a non-volatile manner; the snapshot information is stored in the NVM namespace, and the snapshot information will not be lost even if the computational storage system is accidentally powered off; and a problem that cached data is lost and cannot be restored in related technologies is avoided.

Next, the host is further described as follows.

For example, operation 500 in FIG. 3 can be independently implemented as an example of the operation method of the host; similarly, referring to FIG. 12, the operation method of the host further includes: transmitting, by the host, the capability query information to the computational storage system; and referring to an example corresponding to FIG. 12 for an introduction of the capability query information.

In an optional design, operation 500 may be implemented as any one of the following:
transmitting a command including indication information to a computational storage system, in response to continuous time of execution of a first program in the computational storage system exceeding a time threshold;
for example, when the continuous time of execution of the first program exceeds the time threshold, the first program is a program that needs to be continuously executed, intermediate data of the first program during its execution process is of importance, and cached data obtained in the execution process of the first program may be used during a long period of time, and the cached data in the execution process of the first program needs to be backed up in a manner of snapshot information.
transmitting a command including indication information to a computational storage system, in response to a selected operation for a second program;
for example, when the second program is selected, the second program having importance is selected based on a human-computer interaction operation of a user, and the intermediate data of the second program in its execution process are data having importance manually determined by the user, and cached data in the execution process of the second program needs to be backed up in a manner of snapshot information.
transmitting a command including indication information to a computational storage system, in response to a number of multiple programs executed in parallel in the computational storage system exceeding a number threshold;
for example, when a number of multiple programs that are executed in parallel exceeds a number threshold, programs executed by the computational storage system have high concurrency, and if data in a memory namespace is prevented from being missing, a relatively large number of programs need to be re-executed; and cached data is backed up in a manner of snapshot information, avoiding a problem of data processing efficiency reduction caused by repeated execution of a relatively large number of programs.

In one implementation, in the electronic system shown in FIG. 1, the host is further configured to:
transmitting a command including indication information to a computational storage system, in response to continuous time of execution of a first program in the computational storage system exceeding a time threshold;
or transmitting a command including indication information to a computational storage system, in response to a selection operation for the second program;
or transmitting a command including indication information to a computational storage system, in response to a number of multiple programs executed in parallel in the computational storage system exceeding a number threshold.

In conclusion, according to the method provided in this example, when intermediate data in an execution process of a program is of importance, a host sends a command including indication information to a computational storage system, so that snapshot information is generated in a NVM namespace, and cached data in a memory namespace is backed up in a non-volatile manner. The problem that the cached data is lost and cannot be restored in the related art is avoided.

A person of ordinary skill in the art may understand that, the foregoing examples may be independently implemented, or the foregoing examples may be freely combined to form a new example to implement at least one of the device operation method, the computational storage system operation method, and the host operation method of this application.

In an example of this application, an electronic system is provided, where the electronic system includes a computational storage system and a host, and the computational storage system is coupled to the host;

The host is configured to transmit a command including indication information to the computational storage system;

The computational storage system is configured to: obtain the indication information; and based on the indication information, generate snapshot information for cached data in a memory namespace and store the snapshot information in a NVM namespace.

In an optional implementation of this example, the indication information includes a first field configured to indicate to generate the snapshot information for the cached data in the memory namespace.

In an optional implementation of this example, when the first field is a first value, the first field is configured to indicate to generate the snapshot information for the memory namespace.

In an optional implementation of this example, the indication information further includes at least one of a second field, a third field, and a fourth field;

The second field is configured to indicate a frequency for generating the snapshot information;

The third field is configured to indicate an identity of the NVM namespace;

The fourth field is configured to indicate a start storage location of the snapshot information in the NVM namespace.

In an optional implementation of this example, the computational storage system is further configured to: at a first frequency indicated by the second field, generate the snapshot information for the cached data in the memory namespace and store the snapshot information in the NVM namespace.

In an optional implementation of this example, the computational storage system is further configured to: generate the snapshot information for the cached data in the memory namespace and store the snapshot information in the NVM namespace with the identity indicated by the third field being a first identity.

In an optional implementation of this example, the computational storage system is further configured to: generate the snapshot information for the cached data in the memory namespace, and store the snapshot information in the NVM namespace with a first logical location indicated by the fourth field as a start location.

In an optional implementation of this example, the command is a management command, the management command comprising the indication information, the management command being configured to create a memory range set, the memory range set being a set of at least one memory range in the memory namespace, and the memory range being configured to indicate a segment of memory in a subsystem local memory provided by the computational storage system.

In an optional implementation of this example, the memory range set comprises a memory address of the cached data in the memory namespace, the cached data being at least one of an input cache, an output cache, or a temporary data cache of a program in the computational storage system during execution of the program.

In an optional implementation of this example, the management command further comprises setting information.

The computational storage system is further configured to determine the cached data in the memory namespace based on the setting information, the setting information being configured to indicate a location of the at least one memory range of the memory range set in the memory namespace.

In an optional implementation of this example, the setting information is configured to indicate at least one of the following: a length of the memory range, a memory namespace identity corresponding to the memory range, and a start position of the memory range in the memory namespace.

In an optional implementation of this example, the host is further configured to:
transmitting the command including the indication information to the computational storage system, in response to continuous time of execution of a first program in the computational storage system exceeding a time threshold; or
transmitting the command including the indication information to the computational storage system, in response to a selection operation for a second program; or
transmitting the command including the indication information to the computational storage system, in response to a number of multiple programs executed in parallel in the computational storage system exceeding a number threshold.

In an optional implementation of this example, the computational storage system is further configured to: construct restored cached data in the memory namespace, based on the snapshot information, in the case of missing information in the memory namespace.

In an optional implementation of this example, the computational storage system is further configured to: construct the restored cached data in the memory namespace, based on the snapshot information, in a case that the computational storage system is powered on again after being powered off.

In an optional implementation of this example, the host is further configured to: transmit capability query information to the computational storage system;

The computational storage system is further configured to: obtain the capability query information; and
transmit reply information to the capability query information, the reply information indicating that the computational storage system has a capability of generating the snapshot information in the NVM namespace.

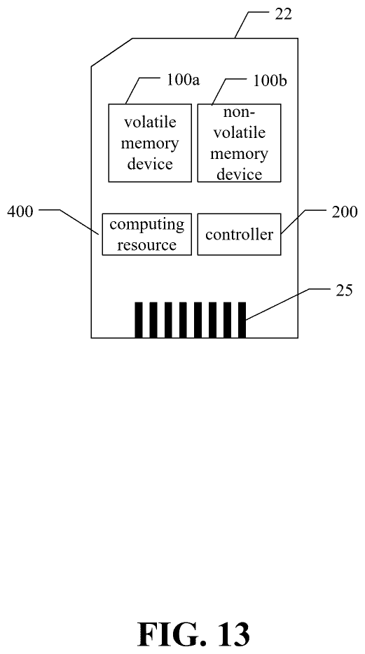

FIG. 13 is a schematic structural diagram of a memory card involved in this application. As shown in FIG. 13, the controller 200 and the single memory device 100 may be integrated into the memory card 22. The memory card 22 may include a personal computer memory card international association (PCMCIA, PC) card, a compact flash (CF) card, a smart media (SM) card, a memory stick, a multi-media card (MMC), an ultra-small MMC (RS-MMC), a micro-MMC, a secure digital (SD) card, a universal flash storage (UFS), or the like. For example, the controller 200 is designed to operate in a low duty cycle environment. As shown in FIG. 13, the memory card 22 may also include a connector 25 that couples the memory card 22 with the host. The memory card 22 includes a controller 200, a volatile memory device 100a and a non-volatile memory device 100b; for example, the volatile memory device 100a has a volatile state of losing data after being powered off, and is a hardware component providing a computing namespace and/or a memory namespace, and the non-volatile memory device 100b does not lose data after being powered off, and is a hardware component providing a NVM namespace. For example, the memory card 22 further includes a computing resource 400, and a hardware component corresponding to the computing namespace is the computing resource 400.

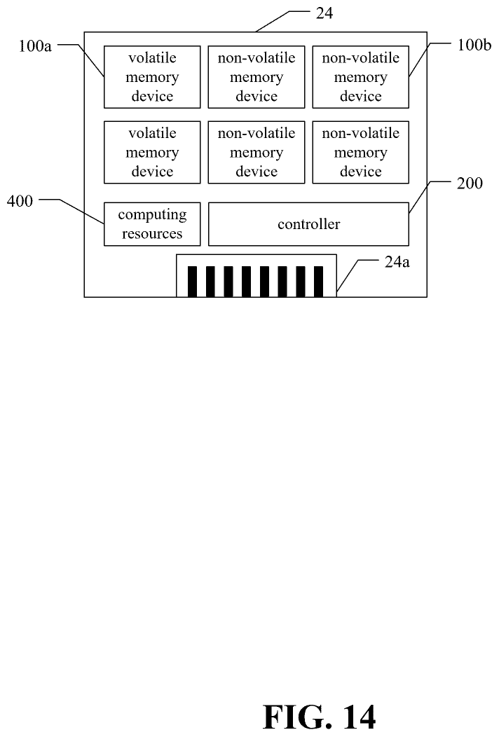

FIG. 14 is a schematic structural diagram of a solid state drive involved in this application. As shown in FIG. 14, the controller 200 and a plurality of memory devices 100 may be integrated into a solid state drive (SSD) 24. The controller 200 is designed to operate in a high duty cycle environment. The solid state drive 24 may also include an SSD connector 24a that couples the solid state drive 24 with a host. For an introduction of the controller 200, the volatile memory device 100a, the non-volatile memory device 100b, and the computing resource 400 in the solid state drive 24, refer to FIG. 13 above, and details are not described herein again.

In an example, a chip is further provided, where the chip includes a programmable logic circuit and/or program instructions, and when the chip runs on a computer device, the chip is configured to implement the operation method of the computational storage system and/or the operation method of the host provided in the foregoing aspects.

In an example, it also provides a computer program product comprising computer instructions stored in a computer readable storage medium. A processor of the computer device reads the computer instructions from the computer readable storage medium, and the processor reads the computer instructions from the computer readable storage medium and executes the computer instructions, to implement the operation method of the computational storage system and/or the operation method of the host provided in the foregoing example methods.

In an example, a computer-readable storage medium is further provided, the computer-readable storage medium storing computer programs, the computer programs are loaded and executed by a processor to implement the operation method of the computational storage system and/or the operation method of the host provided in the foregoing example methods.

A person of ordinary skill in the art may understand that, all or part of the features for implementing the foregoing examples may be implemented by hardware, or may be implemented by instructing related hardware by using programs, where the programs may be stored in a computer-readable storage medium, and the foregoing storage medium may be a read-only memory, a magnetic disk, a compact disk, or the like.

Those skilled in the art should understand that, in one or more of the foregoing examples, functions described in the examples of this application may be implemented by using hardware, software, firmware, or any combination thereof. When implemented using software, these functions may be stored in or transmitted as one or more instructions or code on a computer-readable medium. The computer-readable medium include computer storage medium and communication medium, where the communication medium includes any medium that facilitates transfer of computer programs from one place to another. The storage medium may be any available medium accessible by a general purpose or special purpose computer.

The present disclosure provides an electronic system, a computational storage system, a host and an operation method. The technical solution is as follows:
According to an aspect of the present disclosure, it provides an electronic system including a computational storage system and a host, the computational storage system being coupled to the host;
The host is configured to transmit a command including indication information to the computational storage system;
The computational storage system is configured to: obtain the indication information; and based on the indication information, generate snapshot information for cached data in a memory namespace and store the snapshot information in a non-volatile memory (NVM) namespace.

According to another aspect of the present disclosure, it provides a computational storage system including a controller and a non-volatile memory (NVM) namespace.

The controller is configured to obtain indication information; and
to generate snapshot information for cached data in a memory namespace based on the indication information and store the snapshot information in the NVM namespace.

According to another aspect of the present disclosure, it provides a host coupled to a computational storage system;

The host is configured to transmit a command including indication information to the computational storage system, the indication information indicating to generate snapshot information for cached data in a memory namespace and store the snapshot information in a NVM namespace.

According to another aspect of the present disclosure, an operation method of a computational storage system is provided. The method comprising:
obtaining indication information; and
based on the indication information, generating snapshot information for cached data in a memory namespace and storing the snapshot information in a NVM namespace.

According to another aspect of the present disclosure, an operation method of a host is provided. The method comprising:
transmitting a command including indication information to a computational storage system, the indication information indicating to generate snapshot information for cached data in a memory namespace and store the snapshot information in a NVM namespace.

According to another aspect of this application, a computer-readable storage medium is provided, where the computer-readable storage medium stores at least one instruction, at least one program, a code set, or an instruction set, the at least one instruction, the at least one program, the code set, or the instruction set being loaded and executed by a processor to implement the method for operating a computational storage system and/or the method for operating a host according to the foregoing aspects.

According to another aspect of this application, a computer program product is provided, the computer program product including computer instructions, the computer instructions being stored in a computer-readable storage medium, and a processor reading and executing the computer instructions from the computer-readable storage medium, to implement the method for operating a computational storage system and/or the method for operating a host according to the foregoing aspects.

The foregoing descriptions are merely optional examples of this application, and are not intended to limit this application, and any modification, equivalent replacement, improvement, and the like made within the spirit and principle of this application shall be included in the protection scope of this application.

What is claimed is:

1. An electronic system, comprising:
a computational storage system and a host, the computational storage system being coupled to the host, wherein:
the host is configured to transmit a command including indication information to the computational storage system;
the computational storage system is configured to:
obtain the indication information; and
based on the indication information, generate snapshot information for cached data in a memory namespace and store the snapshot information in a non-volatile memory (NVM) namespace.

2. The electronic system according to claim 1, wherein the indication information comprises a first field configured to indicate to generate the snapshot information for the cached data in the memory namespace.

3. The electronic system according to claim 2, wherein, when the first field has a first value, the first field is configured to indicate to generate the snapshot information of the memory namespace.

4. The electronic system according to claim 2, wherein the indication information further comprises at least one of a second field, a third field, or a fourth field, wherein:
the second field is configured to indicate a frequency to generate the snapshot information;
the third field is configured to indicate an identity of the NVM namespace;
the fourth field is configured to indicate a start storage location of the snapshot information in the NVM namespace.

5. The electronic system according to claim 4, wherein:
the computational storage system is further configured to: at a first frequency indicated by the second field, generate the snapshot information for the cached data in the memory namespace and store the snapshot information in the NVM namespace.

6. The electronic system according to claim 4, wherein:
the computational storage system is further configured to: generate the snapshot information for the cached data in the memory namespace and store the snapshot information in the NVM namespace with the identity indicated by the third field being a first identity.

7. The electronic system according to claim 4, wherein:
the computational storage system is further configured to: generate the snapshot information for the cached data in the memory namespace and store the snapshot information in the NVM namespace with a first logical location indicated by the fourth field as the start storage location.

8. The electronic system according to claim 1, wherein the command is a management command, the management command comprises the indication information, the management command useable to create a memory range set, and the memory range set is a set of at least one memory range in the memory namespace, and the memory range is configured to indicate a segment of memory in a subsystem local memory provided by the computational storage system.

9. The electronic system according to claim 8, wherein the memory range set comprises a memory address of the cached data in the memory namespace, and the cached data is at least one of an input cache, an output cache, or a temporary data cache of a program in the computational storage system during execution of the program.

10. The electronic system according to claim 8, wherein the management command further comprises setting information, wherein:
the computational storage system is further configured to: determine the cached data in the memory namespace based on the setting information, the setting information being configured to indicate a location of the at least one memory range of the memory range set in the memory namespace.

11. The electronic system according to claim 10, wherein the setting information is configured to indicate at least one of a length of the memory range, a memory namespace identity corresponding to the memory range, or a start location of the memory range in the memory namespace.

12. The electronic system according to claim 1, wherein the host is further configured to:
transmit the command including the indication information to the computational storage system, in response to a continuous time of execution of a first program in the computational storage system exceeding a time threshold; or
transmit the command including the indication information to the computational storage system, in response to a selection operation for a second program; or
transmit the command including the indication information to the computational storage system, in response to a number of multiple programs executed in parallel in the computational storage system exceeding a number threshold.

13. The electronic system according to claim 1, wherein:
the computational storage system is further configured to: construct restored cached data in the memory namespace, based on the snapshot information, in a case that information in the memory namespace is missing.

14. The electronic system according to claim 13, wherein:
the computational storage system is further configured to: construct the restored cached data in the memory namespace, based on the snapshot information, in a case that the computational storage system is powered on again after being powered off.

15. The electronic system according to claim 1, wherein:
the host is further configured to: transmit capability query information to the computational storage system;
the computational storage system is further configured to:
obtain the capability query information; and
transmit reply information to the capability query information, the reply information configured to indicate that the computational storage system has a capability of generating the snapshot information in the NVM namespace.

16. A computational storage system, comprising:
a controller; and
a non-volatile memory (NVM) namespace;
the controller is configured to:
obtain indication information; and
based on the indication information, generate snapshot information for cached data in a memory namespace and store the snapshot information in the NVM namespace.

17. The computational storage system according to claim 16, wherein the indication information comprises a first field configured to indicate to generate the snapshot information for the cached data in the memory namespace, wherein, when the first field has a first value, the first field is configured to indicate to generate the snapshot information of the memory namespace.

18. The computational storage system according to claim 17, wherein the indication information further comprises at least one of a second field, a third field, or a fourth field, wherein:
the second field is configured to indicate a frequency to generate the snapshot information;
the third field is configured to indicate an identity of the NVM namespace;
the fourth field is configured to indicate a start storage location of the snapshot information in the NVM namespace.

19. The computational storage system according to claim 16, further comprising a memory device, wherein:
the controller is further configured to: based on the indication information, generate the snapshot information for the cached data and store the snapshot information in the memory device, the cached data being stored in a memory.

20. A method for operating a computational storage system, comprising:
obtaining indication information; and
based on the indication information, generating snapshot information for cached data in a memory namespace and storing the snapshot information in a NVM namespace.
